(19) United States
(12) Patent Application Publication
(10) Pub. No.: US 2015/0149564 A1
(43) Pub. Date: May 28, 2015

(54) METHOD AND SYSTEM FOR PROVIDING MESSAGES TO A USER

(71) Applicant: Wipro Limited, Bangalore (IN)

(72) Inventors: Mohammed Junaid Kottikulam, Kasaragod (IN); Prasanna Prabhu Padmanabha, Ernakulam (IN)

(73) Assignee: Wipro Limited, Bangalore (IN)

(21) Appl. No.: 14/153,791

(22) Filed: Jan. 13, 2014

(30) Foreign Application Priority Data
Nov. 27, 2013 (IN) 5444/CHE/2013

(51) Int. Cl. H04L 12/58

(52) U.S. Cl. CPC H04L 51/14; H04L 51/04; H04L 51/24; H04L 51/32
USPC 709/206

(57) ABSTRACT

This disclosure relates generally to a method and system of providing messages to a user, and more particularly to a method of providing messages to a preferred device and/or message service account of the user. The method includes initially registering one or more devices and/or message service accounts at a managing server. Thereafter, one or more messages received at the registered message service accounts are forwarded to the managing server. Subsequently, the managing server may multicast a notification of the message to all the registered devices and/or service accounts of the user. The notification may include an indication of the registered devices and/or message service accounts of the user. The user may then select a preferred device and/or message service account from the notification. Thereafter, the managing server may forward the message to the preferred device and/or message service account.

### TECHNICAL FIELD

This disclosure relates generally to providing messages to a user, and more particularly to a method and system for providing messages to a preferred device and/or message service account of the user.

### BACKGROUND

With continuing advancements in digital technologies and communications, a user may now communicate and exchange information with other users in numerous ways. Compared to the historic means of postal mailing or telegraphs, current communication systems may be much faster, efficient and reliable.

However, a simultaneous byproduct of current communication systems may be the huge influx of information to an individual from several sources, known or unknown. Currently, in a society, an individual may be associated with several mediums and platforms for receiving information but the individual may hardly have any choice or control over the source of information. As a result, the individual may be lost in this sea of information. In such a scenario, it may seem obvious that a person may tend to ignore reading such messages or at least procrastinate in reading the messages. In some other scenarios, the individual may not even be around the device when the message is sent to the device. The outcome of this behavior is that the person may leave some important/critical message unattended which otherwise may need an urgent response or an action or immediate attention.

### SUMMARY

In one embodiment, a method of providing messages to a user is disclosed. The method comprises: registering at least one of at least one device or at least one message service account associated with the user at a managing server; receiving a message from one of the at least one of the at least one device or the at least one message service; multicasting, by the managing server, a notification of the message to the at least one of the at least one device or the at least one message service account, wherein the notification comprises an indication of the at least one of the at least one device or the at least one message service account associated with the user; receiving, from the user, a selection of one of the at least one device or the at least one message service from the indication of the at least one of the at least one device or the at least one message service account; and providing the message to the selected at least one of the at least one device or the at least one message service account.

In another embodiment, a system for providing messages to a user is disclosed. The system comprises a processor; and a memory disposed in communication with the processor and storing processor-executable instructions, the instructions comprising instructions to: register at least one of at least one device or at least one message service account associated with the user at a managing server; receive a message from one of the at least one of the at least one device or the at least one message service; multicast a notification of the message to the at least one of the at least one device or the at least one message service account, wherein the notification comprises an indication of the at least one of the at least one device or the at least one message service account associated with the user; receive from the user a selection of one of the at least one device or the at least one message service from the indication of the at least one of the at least one device or the at least one message service account; and provide the message to the selected at least one of the at least one device or the at least one message service account.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 illustrates an exemplary environment where various embodiments of the disclosure may function.

FIG. 2 is a flow chart of a method of providing messages to a user according to some embodiments of the present disclosure.

FIG. 3 is a block diagram for providing messages to a user according to some embodiments of the present disclosure.

FIG. 4 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

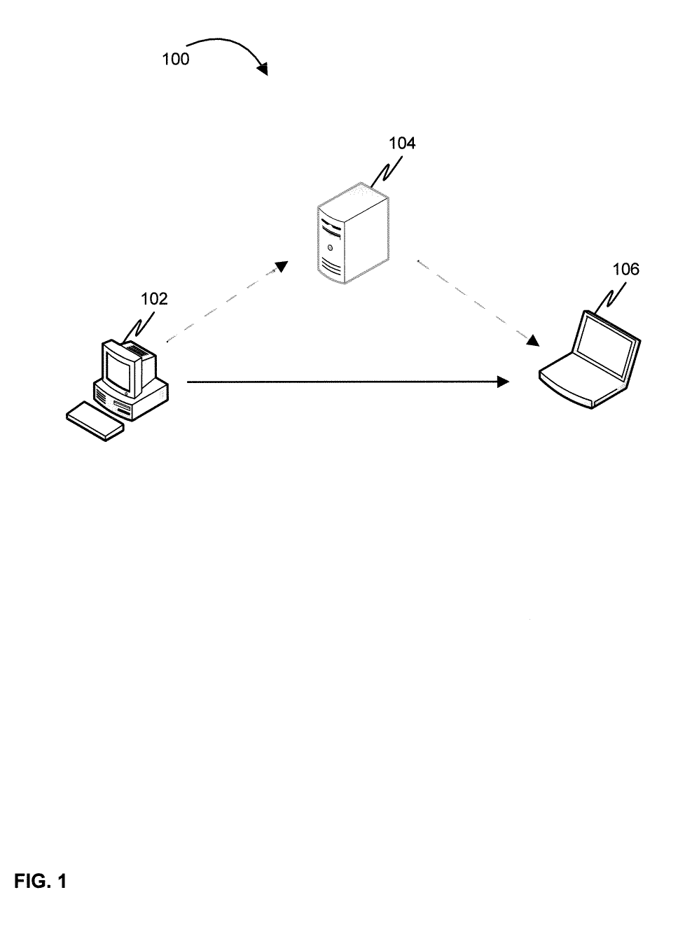

FIG. 1 illustrates an environment 100 in which various embodiments of the disclosure may function. Environment 100 includes a sending device such as a desktop computer 102 using which a sender may send a message over a network (not shown in FIG. 1) such as the Internet. The sender may compose a message such as an email, an instant message, or a social network message and choose one or more recipients to whom to send the message. For example, if Bob (sender) wishes to send a message such as an email to Alice (recipient), Bob may compose the email using an email application on desktop 102 and send the email to Alice by selecting Alice's email contact information. Similarly, Bob may send instant messages or social network messages to Alice using Alice's instant messaging contact information or social network contact information respectively.

The messages sent from the sending desktop computer 102 may, in some embodiments, be routed via a message server 104 to a recipient device such as Alice's laptop 106. Message server 104 may include, but is not limited to a mail server, an instant message server, or a social network server. When Bob sends the message, the application that Bob is using to send the message may connect to message server 104 and pass to message server 104, the name of the recipient, the name of the sender and the body of the message. Message server 104 may then process these pieces of information and accordingly provide the message to the intended recipient. In this case, Alice may log into an application on laptop 106 to view the message. If the message is an email, Alice may log into an email application. Similarly, if Alice wants to view instant messages or social network messages addressed to her, she may log into a corresponding instant messaging application or social network application. Once Alice logs into the desired applications, the messages intended for her may be retrieved from message server 104 and provided to her.

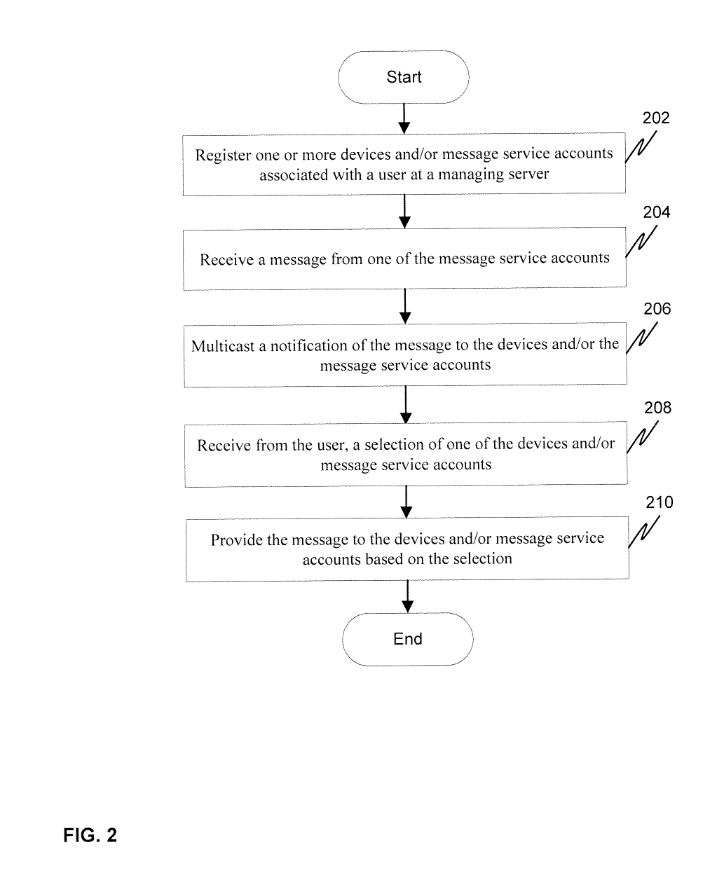

A method of providing messages to a user in accordance with the present disclosure will now be described in conjunction with FIG. 2. The method may include initially requiring the user to register one or more devices and/or message service accounts associated with the user at a managing server at step 202. The one or more devices may include any device which is capable of accessing the internet. In some embodiments, the devices may include, but is not limited to, a smartphone, a tablet computer, a set top box, a smart television, a laptop computer, a desktop computer, a Personal Digital Assistant (PDA), a portable media player, a gaming console, a smart camera, a smart camcorder, a smart watch, a wearable computer, and a Digital media receiver. Additionally or alternatively, the user may also register one or more message service accounts associated with the user. For example, the user may register one or more email accounts, one or more instant messaging accounts, one or more social media accounts, one or more Short Messaging Services (SMS), one or more Multimedia Messaging Services (MMS), and one or more feed aggregator accounts with the managing server. In some embodiments, the managing server may provide a user interface to enable the user to register the one or more devices and/or message service accounts associated with the user. In some other embodiments, a client application may be installed on each of the devices, using which the devices and/or message service accounts may be registered at the managing server. It will be apparent to a person skilled in the art that the client application may be installed during manufacture of the one or more devices or may be downloaded as a standalone application at a later point in time.

After the user's devices and/or message services are registered at the managing server, the managing server, in some embodiments, may monitor message servers associated with each of the registered message service accounts of the user. For example, if the user registers a Gmail™ account and a Skype™ account, the managing server may monitor the Gmail™ server and the Skype™ server to identify any new messages that are received at these message servers for the user. The managing server may use public Application Program Interfaces (APIs) associated with the message server to obtain user login status, user activity status, and information corresponding to unattended or unread messages. Once a new message is received at the message server and is not accessed within a particular period of time, the managing server may retrieve the message from the message server. In other words, the managing server may “pull” the message from the message server. Hence, the message is received at the managing server at step 204.

In some other embodiments, the message server may be configured to automatically forward messages corresponding to a user account registered at the managing server to the managing server. For example, if Joe registers his Gmail™ account with the managing server, then messages that are received by the Gmail™ server that are addressed to Joe may be automatically forwarded to the managing server.

Optionally, in some embodiments, the message server or the managing server may process the messages based on one or more predefined criteria to determine if a message is important or critical. If the message is determined to be important, then further steps may be performed, else the message may be discarded. The message server, on receiving the message addressed to a recipient from a sender, may identify an important message based on one or more predefined parameters such as, but not limited to, name of the sender, criticality flag associated with the message, time at which the message is sent, and one or more keywords in the message

In some other embodiments, the messages that are received at the message service accounts at the user device via the message server may be automatically forwarded to the managing server by a client application installed on the user's device. In some embodiments, the messages may be automatically forwarded to the managing server if the message is not accessed or read within a predefined time period. The managing server may receive the messages at step 204. To enable the automatic forwarding, the client application installed on each of the user's devices may use public Application Program Interfaces (APIs) associated with the various message services to determine when new messages are received at the message service accounts and accordingly forward the messages to the managing server.

In some embodiments, the client application may filter the messages received at a message service account based on one or more predefined criteria prior to forwarding the messages to the managing server. For example, the user may specify that only important or critical messages may be forwarded to the managing server. The client application may thus filter the messages based on one or more criteria predefined by the user and only forward the important messages to the managing server. The client application may identify an important message based on one or more predefined parameters such as, but not limited to, name of the sender, criticality flag associated with the message, time at which the message is sent, and one or more keywords in the message.

In some other embodiments, the messages may be automatically filtered by the client application based on an historical analysis of the user's behavior with respect to messages. For example, if the average time taken by the user to respond to an email from a first sender is lower than average time taken for emails from a second sender, then the client application may deduce that emails emanating from the first sender are important and are to be forwarded to the managing server. Similarly, the number of message exchanges between the user and the sender and the frequency of exchanges may be used to determine if a message is important. It will be apparent to a person skilled in the art that various other mechanisms may be used to identify important messages without deviating from the scope of the invention.

Determining if a message is an important message may, in some embodiments, be performed by a preprocessing module at the managing server. The client application associated with a device may forward messages received at the registered message service accounts to the preprocessing module. The preprocessing module may then identify an important or critical message as explained in conjunction with the client application above.

On receiving a message, the managing server, at step 206, may multicast a notification of the message to the devices and/or message service accounts registered by the user at step 202. The notification may include, in some embodiments, a preview of the message, the name of the sender of the message and level of importance of the message. Further, the notification may also include an indication of all the devices and/or the message service accounts associated with the user. The indication of the devices and/or the message service accounts may be a listing of the devices and/or the message service accounts. The user may select one or more preferred devices and/or message service accounts from the notification. Since the notification is multicasted to all the devices and/or message service accounts of the user, the user may interact with the notification on any of the devices or the message service accounts and select one or more preferred devices and/or message service accounts on which to receive the message. This selection may be received by the managing server at step 208. Thereafter, at step 210, the managing server may provide the message associated with the notification to the selected devices and/or message service accounts. In some embodiments, the original format of the message may be transformed to comply with a format associated with the selected device and/or message service account.

An exemplary embodiment of a method of providing messages will now be explained. Assume a user, Jeff, has registered his Gmail™ account, his Facebook™ account, his smartphone and his tablet with the managing server. An email addressed to Jeff may be received at the Gmail™ mail server. However, Jeff may not be currently logged into his Gmail™ account. In this case, the managing server may poll the Gmail™ mail server periodically for unread mails using Public APIs. In another embodiment, the Gmail™ mail server may push the unread emails to the managing server. If an unread email is found, the managing server may fetch the email from the Gmail™ server and send a notification to Jeff s Gmail™ account, Facebook™ account, smartphone and tablet. In case of the smartphone and the tablet, a client application running on the devices may display the notification. Jeff may then interact with the notification on one of the Gmai1™ account, the Facebook™ account, the smartphone or the tablet and choose to direct the email to the smartphone. The managing server may further convert the email to be displayed properly via a client application running on the smartphone. The managing server may then “push” the email to the client application on the smartphone to be displayed to Jeff or the client application running on the smartphone may “pull” the email from the managing server.

In another exemplary embodiment, Pam may have registered her Gmail™ account, Facebook™ account, smartphone and Tablet with the managing server. Pam may receive an email in the Gmail™ client application running in the Tablet, where she is currently not active. In this case, the client application running on the tablet may forward the email to the managing server, which in turn sends notifications to all of Pam's registered devices and/or message service accounts. Pam may then interact with the notification and choose to direct the email to the Facebook™ account. The managing server may format the email to be compatible with Facebook™ and may forward the email to the Facebook™ server using public APIs.

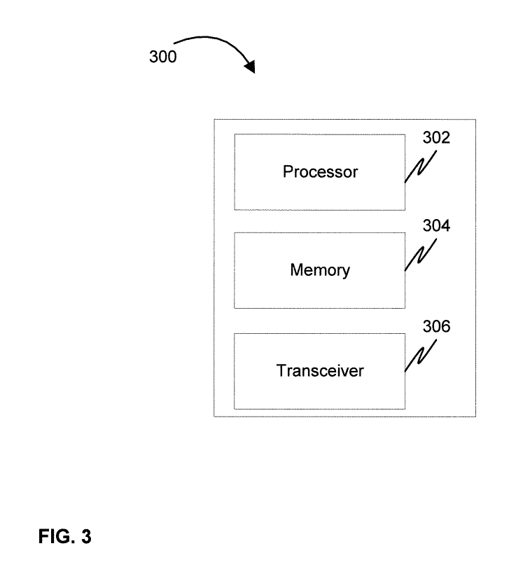

A system 300 for providing messages to a user will now be explained in conjunction with FIG. 3. System 300 includes a processor 302 and a memory 304 disposed in communication with processor 302 and storing processor-executable instructions, the instructions comprising instructions to register one or more devices and/or message service accounts associated with the user. Here, the user may register the one or more devices and/or message service accounts and the processor-executable instructions may log these registrations. The user may register any device which is capable of accessing the internet as specified in conjunction with FIG. 2.

After the user's devices and/or message services are registered, processor 302 may, in some embodiments, monitor message servers associated with each of the registered message service accounts of the user. Processor 302 may use public Application Program Interfaces (APIs) associated with the message server to obtain user login status, user activity status, and information corresponding to unattended or unread messages. Once a new message is received at the message server and is not accessed within a particular period of time, processor 302 may retrieve the message from the message server. System 300 may further include one or more transceivers such as transceiver 306 to receive the message from the message server. In some other embodiments, processor 302 may receive the message from a client application running on a user's device as explained in detail in conjunction with FIG. 2.

On receiving the message, the message may be stored in memory 304. Thereafter, processor 302 may cause transceiver 306 to multicast a notification of the message to the one or more devices and/or message service accounts. The notification may include, in some embodiments, a preview of the message, the name of the sender of the message and level of importance of the message. Further, the notification may also include an indication of all the devices and/or the message service accounts associated with the user. The indication of the devices and/or the message service accounts may be a listing of the devices and/or the message service accounts. The user may select one or more preferred devices and/or message service accounts from the notification. Thereafter, processor 302 may cause the message stored in memory 304 to be provided to the one or more preferred devices and/or message service accounts selected by the user.

Computer System

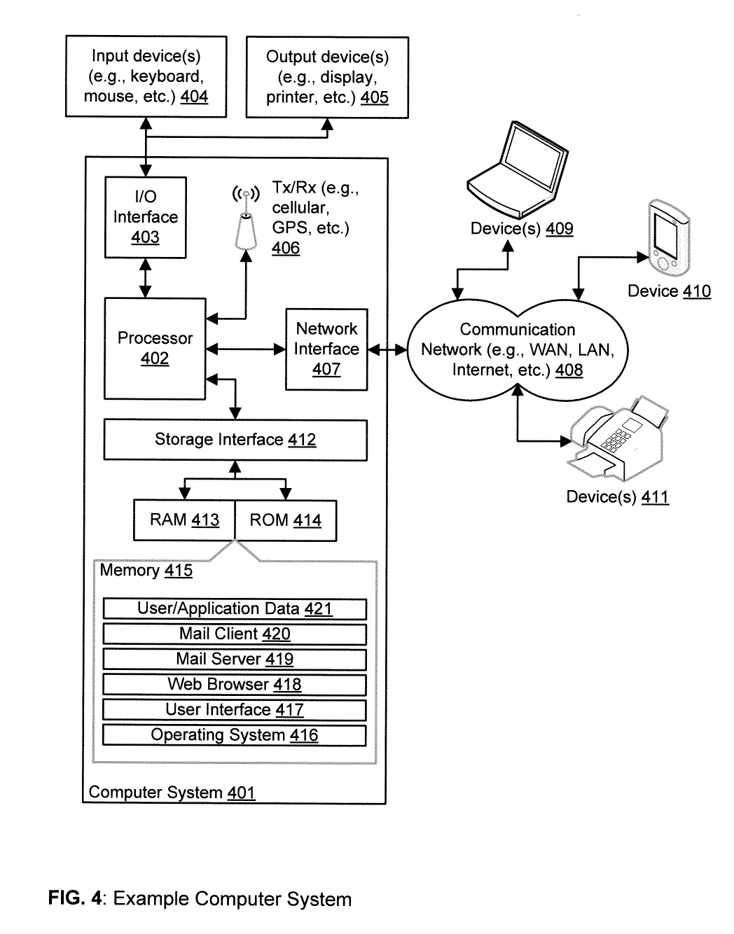

FIG. 4 is a block diagram of an exemplary computer system for implementing embodiments consistent with the present disclosure. Variations of computer system 401 may be used for implementing a managing server for providing messages to a user. Computer system 401 may comprise a central processing unit (“CPU” or “processor”) 402. Processor 402 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 402 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 402 may be disposed in communication with one or more input/output (I/O) devices via I/O interface 403. The I/O interface 403 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 403, the computer system 401 may communicate with one or more I/O devices. For example, the input device 404 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 405 may be a printer, fax machine, video display (e.g., cathode ray tube (CRT), liquid crystal display (LCD), light-emitting diode (LED), plasma, or the like), audio speaker, etc. In some embodiments, a transceiver 406 may be disposed in connection with the processor 402. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 402 may be disposed in communication with a communication network 408 via a network interface 407. The network interface 47 may communicate with the communication 408. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 408 may include, without limitation, a direct interconnection, local area network (LAN), wide area network (WAN), wireless network (e.g., using Wireless Application Protocol), the Internet, etc. Using the network interface 407 and the communication network 408, the computer system 401 may communicate with devices 409, 410, and 411. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox,

Nintendo DS, Sony PlayStation, etc.), or the like. In some embodiments, the computer system 401 may itself embody one or more of these devices.

In some embodiments, the processor 402 may be disposed in communication with one or more memory devices 415 (e.g., RAM 413, ROM 414, etc.) via a storage interface 412. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 416, user interface application 417, web browser 418, mail server 419, mail client 420, user/application data 421 (e.g., any data variables or data records discussed in this disclosure), etc. The operating system 416 may facilitate resource management and operation of the computer system 401. Examples of operating systems include, without limitation, Apple Macintosh OS X, Unix, Unix-like system distributions (e.g., Berkeley

Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 417 may facilitate display, execution, interaction, manipulation, or operation of program components through textual or graphical facilities. For example, user interfaces may provide computer interaction interface elements on a display system operatively connected to the computer system 401, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 401 may implement a web browser 418 stored program component. The web browser may be a hypertext viewing application, such as Microsoft Internet Explorer, Google Chrome, Mozilla

Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 401 may implement a mail server 419 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 401 may implement a mail client 420 stored program component. The mail client may be a mail viewing application, such as Apple Mail, Microsoft Entourage, Microsoft Outlook, Mozilla Thunderbird, etc.

In some embodiments, computer system 401 may store user/application data 421, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for providing messages to a user, the method comprising:
registering, by a message management computing device, at least one of at least one device or at least one message service account associated with the user at a managing server;
receiving, by the message management computing device, a message from one of the at least one message service account;
multicasting, by the message management computing device, a notification of the message to the at least one of the at least one device or the at least one message service account, wherein the notification comprises an indication of the at least one of the at least one device or the at least one message service account associated with the user;
receiving, by the message management computing device, a selection of one of the at least one device or the at least one message service from the indication of the at least one of the at least one device or the at least one message service account; and
providing, by the message management computing device, the message to the one of the at least one of the at least one device or the at least one message service account based on the selection.

2. The method of claim 1, wherein the at least one device is an internet enabled device.

3. The method of claim 1, wherein a message comprises one of an instant message, an e-mail, a social network message, a feed aggregator message, a Short Messaging Service (SMS) message, and a Multimedia Messaging Service (MMS) message.

4. The method of claim 1, further comprising converting, by the message management computing device, an original format of the message to a format compatible with the selected one of the at least one device or the at least one message service.

5. A message management computing device comprising:
a processor;
a memory, wherein the memory coupled to the processor which are configured to execute programmed instructions stored in the memory comprising
registering at least one of at least one device or at least one message service account associated with the user;
receiving a message from one of the at least one message service account;
multicasting a notification of the message to the at least one of the at least one device or the at least one message service account, wherein the notification comprises an indication of the at least one of the at least one device or the at least one message service account associated with the user;
receiving a selection of one of the at least one device or the at least one message service from the indication of the at least one of the at least one device or the at least one message service account; and
providing the message to the one of the at least one of the at least one device or the at least one message service account based on the selection.

6. The device of claim 5, wherein the at least one device is an internet enabled device.

7. The device of claim 5, wherein a message comprises one of an instant message, an e-mail, a social network message, a feed aggregator message, a Short Messaging Service (SMS) message, and a Multimedia Messaging Service (MMS) message.

8. The device of claim 5 wherein the processor is further configured to execute programmed instructions stored in the memory further comprising converting an original format of the message to a format compatible with the selected one of the at least one device or the at least one message service.

9. A non-transitory computer readable medium having stored thereon instructions for providing messages to a user comprising machine executable code which when executed by at least one processor, causes the processor to perform steps comprising:
registering at least one of at least one device or at least one message service account associated with the user;
receiving a message from one of the at least one message service account;
multicasting a notification of the message to the at least one of the at least one device or the at least one message service account, wherein the notification comprises an indication of the at least one of the at least one device or the at least one message service account associated with the user;
receiving a selection of one of the at least one device or the at least one message service from the indication of the at least one of the at least one device or the at least one message service account; and
providing the message to the one of the at least one of the at least one device or the at least one message service account based on the selection.

10. The medium of claim 9 wherein the at least one device is an internet enabled device.

11. The medium of claim 9 wherein a message comprises one of an instant message, an e-mail, a social network message, a feed aggregator message, a Short Messaging Service (SMS) message, and a Multimedia Messaging Service (MMS) message.

12. The medium of claim 9 further comprising converting an original format of the message to a format compatible with the selected one of the at least one device or the at least one message service.
